(19) United States
(12) Patent Application Publication
(10) Pub. No.: US 2011/0298188 A1
(43) Pub. Date: Dec. 8, 2011

(54) Construction Machine And A Method For Controlling And/Or Monitoring The Milling Depth Of A Construction Machine

(75) Inventors: Thomas Haubrich, Goedenroth (DE); Marcus Schmitz, Oberzissen (DE); Robert Laux, Neuwied (DE); Markus Lang, Pleizenhausen (DE); Martin Werner, Kruft (DE)

(73) Assignee: BOMAG GMBH, Boppard (DE)

(21) Appl. No.: 13/083,683

(22) Filed: Apr. 11, 2011

(30) Foreign Application Priority Data
Apr. 11, 2010 (DE) 10 2010 014 549.1
Nov. 4, 2010 (DE) 10 2010 050 441.6

(51) Int. Cl. B60G 17/00

(52) U.S. Cl. 280/6.155

(57) ABSTRACT

The invention relates to a construction machine, especially a road construction machine, comprising a machine frame and a chassis carrying the machine frame with several wheels, with at least one of the wheels being connected with the machine frame via a height-adjustable lifting column and the lifting column comprises a distance measuring device for measuring the adjustment of the lifting columns with a sensor. The invention further relates to a method for controlling and/or monitoring the working depth of a working device for processing the ground arranged on a height-adjustable construction machine, especially a road construction machine.

### FIELD OF THE INVENTION

The present invention relates to a construction machine, such as a road construction machine for road processing, a road milling machine or cold milling machine, a recycler or a stabilizer, and a method for controlling and/or monitoring the working depth of a working device for processing the ground.

### BACKGROUND OF THE INVENTION

In a number of construction machines, height adjustment of the construction machine, and especially a machine frame of the construction machine, is desirable with respect to the ground. Typical construction machines with such a height-adjustment function are self-propelled road construction machines, especially of the type of a road or cold milling machine, recycler or stabilizer. These construction machines are used for processing the ground and usually comprise a working drum which is arranged on the machine frame for this purpose, the rotation axis of which extends horizontally and transversely to the longitudinal direction of the machine frame. The working drum thus rotates in working operation in the forward and rearward direction of the construction machine.

Depending on the embodiment, the working drum can be arranged either in a stationary manner on the machine frame or in a pivotable manner on the machine frame in relation to the machine frame. The machine frame is carried by a chassis which comprises at least one front wheel and two rear wheels. Instead of wheels it would also be possible to use caterpillar gondolas.

In order to achieve height adjustability of the machine frame of the construction machine, at least one of the wheels is connected with the machine frame via a lifting column which is height adjustable or is adjustable in the vertical direction. Preferred embodiments provide that the chassis comprises at least two rear wheels which are each connected via a lifting column with the machine frame. In this embodiment, the rear part of the machine frame in which also the working drum is frequently arranged is thus variable in its height, so that the working drum can be lowered into the ground to be processed for example by lowering the rear part of the construction machine. Alternatively, all wheels such as one or two front wheels and two rear wheels can also be connected via a lifting column with the machine frame in order to thus achieve height adjustability of the entire machine for example.

It is especially important for the operator of the construction machine to obtain information in working operation on the lifting state of the construction machine. The working depth of the working drum in the ground to be processed is often controlled via the lifting and lowering of the machine frame for example, which is especially the case when the working drum is held in a stationary manner relative to the machine frame. It is known for this purpose and/or for monitoring the working depth to arrange a distance measuring device with a sensor on the outside of the lifting column, e.g., in the form of a draw-wire sensor. The sensor designates the unit of the distance measuring device which is used directly for determining a measured value, with the distance measuring device comprising a superordinate unit, which also comprises signal lines for example which forward the values determined by the sensor to a control unit which may optionally be present and is partly connected with the distance measuring device, etc. The usually employed sensors, especially draw-wire sensors, are disadvantageous as a result of their rapid wear and tear.

The distance measuring device arranged on the outside of the lifting column further has the tendency to become dirty during working operation, which has a disadvantageous effect on the functional integrity and thus on the reliability of the determined lifting states. Moreover, the distance measuring device is subjected to weathering influences, which may also lead to malfunctions. Finally, the application of the distance measuring device on the outside of the lifting column is often perceived as obstructive as a result of its properties where it protrudes from the outside surface of the lifting column, especially in maneuvering operation or during work in cramped conditions, e.g., when working close to the edge of a wall of a building.

It is a further special problem of the previously known arrangements for determining the lifting state of the construction machine that when transferring to construction machines with at least one horizontally pivotable wheel, the dependence of the lifting states of the construction machine on the various positions of the pivotable wheel in the horizontal plane is not taken into account and will therefore function reliably and correctly only in one specific position of the pivotable wheel. This leads to the consequence however that the operator of the construction machine cannot use the distance measuring device at all or only to a very limited extent in pivoting states which lie outside of this specific position.

It is therefore an object of the present invention to provide a generic construction machine which enables a reliable and permanent control and/or monitoring of the lifting state of the construction machine. The present invention further provides a method which enables a reliable control and/or monitoring of the lifting state of the construction machine with a wheel which is pivotable in the horizontal plane.

### SUMMARY OF THE INVENTION

One relevant aspect of the present invention is that the sensor is integrated in the lifting column. In contrast to the previously known embodiments, there is thus no positioning of the sensor on the outside surface of the lifting column in a protruding fashion. The sensor is rather transferred into the lifting column. In the most extreme of cases, the sensor is thus flush with the outside surface of the lifting column which is adjacent to the sensor. The sensor and the lifting column thus form a common enclosed and protrusion-free outside surface to the outside.

In order to maintain the advantages in accordance with the present invention, it is preferred however when the sensor is arranged in the interior or in an interior space of the lifting column. The sensor is thus placed in this embodiment in the lifting column and is enclosed on the outside by the lifting column. The sensor is thus protected from weathering influences and can thus supply reliable measure data over considerably longer operating periods.

All such sensors are suitable for integration in the lifting column which, with regard to space, can be integrated in the lifting column or housed in the lifting column on the one hand, and enable the determination of the required actuating paths between the maximum lifted and maximum lowered position with sufficient precision on the other hand. Preferred actuating paths lie in the region of up to 1 m and especially up to 60 cm for example. Such sensors can be potentiometric sensors, inductive sensors optical sensors, etc. One type of sensor which is suitable for use in the present invention determines the lifting state with the help of a magnetostrictive measuring principle. This sensor shall also be referred to below as an “MG sensor”. The MG sensor thus comprises a displacement transducer which determines the distance between two points with the help of magnetostriction. The MG sensor is especially advantageous in the respect that it ideally enables a contactless and thus practically wear-free distance measurement.

The MG sensor can principally be realized in different ways. Preferably, the MG sensor comprises a signal transducer which is arranged on the face-side end of a sensor rod and a position magnet which is displaceable along the longitudinal axis of the sensor rod, ideally in a contactless manner. The individual elements of the MG sensor are arranged in the lifting column in such a way that after a change of the lifting position the distance between the position magnet and the signal transducer will change along the longitudinal axis of the sensor rod. For the purpose of the actual measurement, a short current pulse originating from the signal transducer is sent through the waveguide, thus producing a locally changing first magnetic field which travels with the pulse. The permanent magnet guided along the sensor rod is enclosed by a second magnetic field. The collision of the two magnetic fields triggers a torsion pulse which runs as an acoustic wave with constant ultrasonic speed from the point of origin back to the signal transducer and is converted there into a suitable path-proportional signal. It can then be forwarded for example to a control unit connected to the path-measuring device and can be displayed via a respective display apparatus.

It is also possible to use various alternatives for implementation of the lifting column. The lifting column principally comprises an apparatus with which height adjustment of the machine frame is enabled, with which specifically the adjusting movement of the lifting column in the vertical direction is achieved. Preferably, the lifting column comprises a cylinder/piston unit for this purpose. The lifting column in this embodiment comprises a cylinder, along the cylinder axis of which a piston is guided in a longitudinal displaceable way in the cylinder in an at least partly overlapping manner. The piston can thus be displaced at least partly into the cylinder and can be pulled at least partly out of the piston. A hydraulically actuatable cylinder/piston unit is further preferred in one embodiment. This is advantageous in respect that modern road construction machines usually already comprise an existing hydraulic system, so that the present invention can be implemented rapidly in such construction machines. In order to perform the lifting movement, the piston is thus substantially displaced in the vertical direction in relation to the cylinder.

The lifting column further preferably comprises, in one embodiment, a casing which screens the lifting column towards the outside. The casing is also part of the lifting column in this embodiment. The casing substantially fulfils a screening function and protects the interior of the lifting column from damage from the outside, e.g., from introduction of dirt, etc. Such a casing can be a sleeve for example, in the interior of which the device for height adjustment such as the hydraulic cylinder/piston unit is arranged. The sleeve is preferably arranged with several elements, especially two elements, comprising an upper sleeve and a bottom sleeve. The upper and the bottom sleeve are adjusted to one another in such a way that the one sleeve, e.g., the bottom one (also designated below as the wheel carrier sleeve), is smaller than the other sleeve with respect to the diameter, e.g., the upper sleeve (also designated below as the frame-side sleeve), so that the two sleeves can be slid into one another at least in part. Furthermore, additional sealing elements or the like can be provided in order to seal the overlapping region of the two sleeves to the interior against dirt and/or humidity. The casing can further comprise respective fastening elements such as fixing links with which they are linked to the machine frame. It is now provided in accordance with the present invention that the sensor of the path measuring device is integrated in the lifting column.

Embodiments are also included within the scope of the present invention with respect to a lifting column with a casing in which the sensor is integrated in the casing of the lifting column, e.g., in the wheel carrier sleeve and/or in the frame-side sleeve and/or between the wheel carrier sleeve and the frame-side sleeve. Moreover, such embodiments are also included in which the sensor is arranged between an element or a part of the casing and the device for height adjustment of the lifting column, e.g., a hydraulic cylinder/piston unit. The sensor of the path measuring device therefore need not mandatorily be directly integrated in elements of the lifting column which are responsible for the height adjustment of the lifting column. The sensor can rather also be integrated outside of the preferably provided cylinder/piston unit in other elements of the lifting column, e.g., the casing. It is important in accordance with one embodiment of the present invention that the sensor is displaced into the lifting column (which also includes flush alignment of the sensor with the outside surface of the casing) and thus no longer protrudes to the outside beyond the lifting column.

In order to enable determining the extent of the lifting movement or the specific lifting position with the sensor of the path measuring device which is integrated in the lifting column, the sensor comprises, in one embodiment, a cylinder sensor element arranged in the cylinder of the hydraulic cylinder/piston unit or in the interior space of the hydraulic cylinder/piston unit and a piston sensor element which is arranged in the piston or at least in the interior space of the cylinder/piston unit in the piston. Especially when using an MG sensor, the positioning of the cylinder sensor relative to the piston sensor occurs in the manner that its distance changes with a lifting adjustment of the cylinder/piston unit. The sensor rod of the MG sensor is further arranged in the cylinder/piston unit in a further preferred embodiment in such a way that its longitudinal axis lies coaxially on the longitudinal axis or lifting axis of the cylinder/piston unit. As a result, relatively long actuating paths can be detected reliably for example in a relatively easy manner. It is advantageous with respect to the arrangement of the MG sensor in the cylinder/piston unit when the permanent magnet, the cylinder sensor element and the signal transducer are a piston sensor element, especially a modular unit on the signal transducer with the sensor rod. Alternatively, the MG sensor can also be arranged with a sensor element in the casing and with a further sensor element in a part of the piston/cylinder unit or also exclusively in elements of the casing.

The cylinder/piston unit of the lifting column is arranged, in one embodiment, in the manner that a common and contiguous cavity is present in the interior of the cylinder/piston unit, which cavity is delimited partly by the cylinder and partly by the piston. This cavity is ideal for integrating the sensor in the cylinder/piston unit because there is sufficient space for housing the sensor in the interior of the lifting column. The sensor can thus disappear in the interior of the cylinder/piston unit. This means for the conventional arrangement of the cylinder/piston unit in the machine frame in the manner that the cylinder which is at the top in the vertical direction and is connected with the machine frame is placed from above over the piston which is disposed at the bottom in the vertical direction and carries the wheel that preferably the position magnet is stationary relative to the machine frame in its vertical height and the sensor rod together with its face-side signal transducer is moved past the position magnet by the piston on the permanent magnet, which piston displaces during a lifting adjustment in the vertical direction relative to the machine frame, ideally in a contactless manner. Principally, a reverse arrangement of the individual components of the MG sensor is possible.

The path measuring device can further be arranged for providing direct optical display of the determined measured value. It is considerably more convenient however to provide the control unit which processes the lifting states of the lifting column as determined by the sensor of the path measuring device and displays this on a display apparatus, especially a digital display, which is ideally arranged in a driver cab of the construction machine. The path measuring device comprises respective signal and/or data lines for this purpose, with the help of which the data determined by the sensor are transferred to the control unit.

It is further known to provide a wheel which is pivotable in a horizontal plane in the chassis of the construction machine, especially a rear wheel. In order to facilitate working close to an edge or work in cramped conditions or also the transport of such construction machine, the wheel which is disposed in these machines on the so-called null side can be pivoted in front of the respective working device such as especially a milling drum. If this is not necessary, the wheel is preferably operated in the state laterally protruding beyond the side of the machine frame, in which it usually lies at the height of the working device and coaxially to the wheel disposed on the other side of the construction machine, especially the rear wheel. This is especially the case in road or cold milling machines for example. In the case of operating states in which the pivotable (rear) wheel and the non-pivotable (rear) wheel disposed on the other side of the machine frame do not lie at the same level with their contact area to the ground or do not lie on a line orthogonally to the forward direction of the construction machine, it is necessary to achieve different lifting positions in the respective two lifting columns in order to keep the construction machine horizontally with respect to its lateral position.

A further relevant aspect of the present invention is that a control unit is provided that is preferably arranged in a manner that it comprises a corrective function for compensating various pivoting positions of one of the (rear) wheels relative to a non-pivotable (rear) wheel. This corrective function therefore takes into account the differential amount with respect to the height offset of the (rear) wheels which are laterally adjacent in the axial direction and displays respectively corrected values in the display. This function will be used especially when the path measuring device is used for determining the working depth, e.g., the milling depth. It is understood that the corrective function integrated in the control unit will also work with other path measuring devices, e.g., with a path measuring device arranged on the outside of the lifting column for example, and is not linked to the integration of the sensor in the lifting column.

It is principally sufficient to provide only the at least one lifting column of the construction machine with a path measuring device in the manner in accordance with the present invention. In order to still enable drawing conclusions on the milling depth of a road milling machine for example, a bubble level can additionally be arranged on the machine for example which indicates the inclination of the machine to the driver. The advantages offered by the present invention can further be increased if the construction machine comprises several lifting columns with a path measuring device in accordance with the present invention. Exceptional embodiments are obtained when at least the two rear wheels of the construction machine are each provided with the lifting column and each comprise a path measuring device in accordance with the present invention. The variability of the various lifting positions of the construction machine can further be increased when all wheels provided on the chassis are each arranged with a lifting column on the machine frame which comprises a path measuring device in accordance with the present invention. In these embodiments of the present invention in which more than one path measuring device supplies data on the lifting state of a lifting column as determined by the sensor, the data are preferably processed in a combined manner in a common control unit. The output of the measurement data processed by the control unit preferably occurs in the manner however that in the display the determined lifting states of each lifting column equipped with a path measuring device are output separate from one another in order to inform the operator in the highest possible detail.

Another aspect of the present invention lies in a method for controlling and/or monitoring the working depth of a working device for processing the ground which is held on a height-adjustable construction machine. The construction machine for performing the method in accordance with the present invention typically comprises a height adjustable machine frame which is carried by a chassis, to which at least one wheel of the chassis is linked in a horizontally pivotable manner, especially a rear wheel, comprising at least one lifting column for the height adjustment of the machine frame relative to the wheel, and a path measuring device which comprises a control unit and a sensor which is connected with the lifting column and is especially integrated in the lifting column. The method in accordance with the present invention comprises several relevant steps.

The lifting position of the at least one lifting column is determined at first with a sensor, especially a sensor arranged in the manner as described above. This can occur for example with respect to a previously adjusted initial value or zero value. The different filling states of the tires can thus be considered in this manner for example. It is also possible however to refer to a fixed reference value. The at least one measured value is sent to the control unit. If there are several lifting columns with suitable path measuring devices, especially two lifting columns of two rear wheels equipped with a path measuring device each (of which one is pivotable in a horizontal plane between an inwardly pivoted position and an outwardly pivoted position), e.g., of a road milling machine, the measured values of all path measuring devices are determined and sent to the control unit.

The control unit further queries the current pivoting position of the wheel that can be pivoted in one horizontal plane, especially the rear wheel. Respective sensors are provided for this purpose for example, via which the pivoting position can be determined. A software-based solution is alternatively also possible, which provides the pivoting position of the respective wheel to the control unit on the basis of control commands.

The imprecision in the measurement and the output of the lifting state which is accompanied by the various pivoting states can be especially serious if conclusions are drawn on the working depth of a working device lowered into the ground to be processed with the help of the path measuring device, as is especially the case in road milling machines. Without the corrective function, values are stated which may under certain circumstances deviate considerably from the actual milling or working depth (also referred to below as “actual working depth”), which makes it extremely difficult for the operator of the road milling machine to perform precise milling work, irrespective of the pivoting state of the pivotable rear wheel. It is therefore provided within the scope of the method in accordance with the present invention that the control unit corrects the lifting position detected by the sensor depending on the queried pivoting position of the pivotable wheel and states the actual working depth of the milling drum in this way.

It is provided in a preferred embodiment that the method in accordance with the present invention enables the manual fixing of a zero point. If the operator activates this function, the control unit refers all subsequent changes in the measurement value to this zero point defined irrespective of the actual lifting position. For this purpose, the milling drum can be moved from a lifted transport position to a position resting on the ground to be processed in which the zero point is then subsequently determined. As a result of the corrective function, the pivotable (rear) wheel can be changed in its pivoting position without having any effect on the data on the actual working depth as output by the control unit. The previously determined zero point can thus be maintained for example.

### BRIEF DESCRIPTION OF THE DRAWINGS

The present invention will now be explained in closer detail by reference to embodiments schematically shown in the drawings, wherein:

FIG. 1 shows an oblique view of a road construction machine;

FIG. 2 shows a principal top view of the road construction machine of FIG. 1;

FIGS. 3a to 3c show the rear view of the road construction machine of FIGS. 1 and 2 in different lifting positions;

FIG. 4 shows a view of a sectional enlargement of the lifting column of the pivoting wheel of FIGS. 1 and 2 from the front;

FIGS. 5a to 5e show longitudinal and cross-sectional views of the lifting column of FIG. 4;

FIGS. 6a and 6b shows side views of the road construction machine of the preceding drawings; and

FIG. 7 shows a flowchart of the corrective function.

In the drawings, identical reference numerals denote structurally or functionally equivalent components. Not all components repeated in the drawings are designated in each drawing.

### DETAILED DESCRIPTION OF THE INVENTION

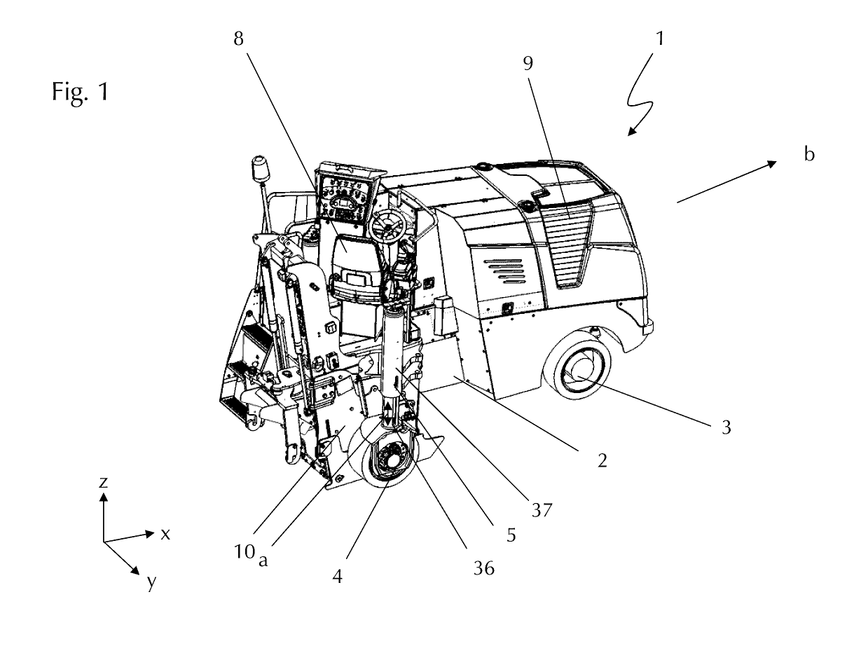

The construction machine as shown in FIG. 1 comprises a cold milling machine 1. A relevant element of the cold milling machine 1 is a machine frame 2, on which a pair of front wheels (only the front right wheel 3 is shown in FIG. 1) and a pair of rear wheels (only the right rear wheel 4 is shown in FIG. 1) are arranged. Embodiments are alternatively also possible in which only one front wheel 3 is provided. The rear wheels 4 are each linked via a lifting column 5 (only the lifting column 5 arranged on the right side is shown in FIG. 1) to the machine frame and are arranged to be height-adjustable in the vertical direction along the direction arrow a. The lifting column comprises a sleeve-like casing which is substantially formed by an upper sleeve 37 and the bottom sleeve 36. The two sleeves partly overlap and the bottom sleeve 36 can partly be slid into the upper sleeve 37. Both sleeves 36 and 37 are arranged in the manner of a hollow cylinder and jointly form a common interior space, in which a cylinder 6 (not shown in FIG. 1) and a piston 7 (not shown in FIG. 1) of a hydraulic cylinder/piston unit are arranged. The required actuating force for the height adjustment of the lifting column 5 is finally introduced via this cylinder/piston unit. The rear wheel 4 is held at the bottom end of the bottom sleeve 36 and the upper sleeve 37 which is disposed above in the vertical direction is connected via respective connecting links with the machine frame 2. The two lifting columns 5 on the real wheels 4 allow lowering the machine in the rear region, so that the milling depth FT can be changed for example by means of different lifting positions.

In order to enable milling close to the edges with the cold milling machine 1, the rear wheel 4 which is disposed on the side of the machine frame 3 and on which the milling drum not shown in FIG. 1 is virtually flush in alignment with the machine frame (also referred to below as the null side) is arranged to be pivotable from an outwardly pivoted position (according to FIG. 1) protruding from the machine frame 2 to an inwardly pivoted position in which the rear wheel 4 is free from protrusion relative to the machine frame or the face side of the milling drum on the null side. A respective pivoting mechanism is provided for this purpose on the cold milling machine 1. An operator workplace 8 is further arranged in the rear region of the cold milling machine 1, comprising an operator console not designated in closer detail, a seat and further components for guiding the machine.

An internal combustion engine is provided for driving the machine functions, especially the front wheels 3 and/or the real wheels 4 and the pivoting mechanism and the rotation movement of the milling drum, which internal combustion engine supplies a hydraulic system not designated in closer detail with drive power. The internal combustion engine is located in FIG. 1 on the left adjacent to the water tank 9. A milling drum (not shown in FIG. 1) is arranged beneath the operator workplace, which milling drum is enclosed on the sides, to the front and above at least partly by a milling drum box (the upwardly foldable milling drum box door of the milling drum box is designated in FIG. 1 with reference numeral 10). In working operation, the cold milling machine 1 is guided in the working direction b with a milling drum over the ground to be processed, which milling drum rotates around a horizontal axis extending transversely to the working direction a.

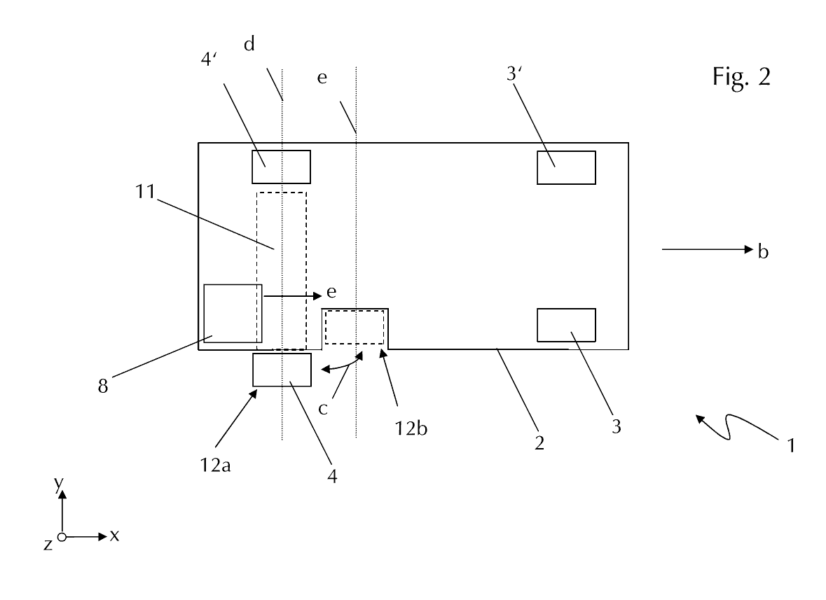

FIG. 2 shows a rough top view, which indicates the position of relevant elements of the cold milling machine 1 with respect to one another. The operator workplace 8 is arranged in the rear part of the cold milling machine 1 and lies above the milling drum 11 with respect to the working direction b. The cylindrical milling drum 11 is virtually flush with the machine frame 2 on the one longitudinal side (on the bottom side in FIG. 1). The milling drum 11 is used for example for removing road surfaces made of concrete, asphalt or the like, and is lowered for this purpose onto the surface to be processed, made to rotate and moved in the direction of arrow b over the road surface. The pivotable rear support wheel 4 which is disposed on the null side is situated in FIG. 2 in its outwardly pivoted position 12a which protrudes beyond the machine frame 2 and can be inwardly pivoted along the direction of arrow c to its inwardly pivoted position 12b (indicated with the broken line) and vice versa. The two wheels (front wheel 3′ and rear wheel 4′) which are opposite one another on the null side, as also the front wheel 3 disposed on the null side, are not pivotable and are rather fixedly connected with the machine frame 2. FIG. 2 further shows that in the outwardly pivoted position of the pivotable rear wheel 4 the two rear wheels 4 and 4′ and the longitudinal axis of the milling drum 11 lie on a common axis d transversely to the working direction b or along the rotational axis of the milling drum 11 in the horizontal plane with respect to the rotational axes. If the rear wheel 4 on the other hand is inwardly pivoted, only the rear wheel 4′ and the milling drum 11 are disposed on the axis d. The inwardly pivoted rear wheel 4 is offset forwardly relative thereto in the working direction b and lies on the parallel axis e.

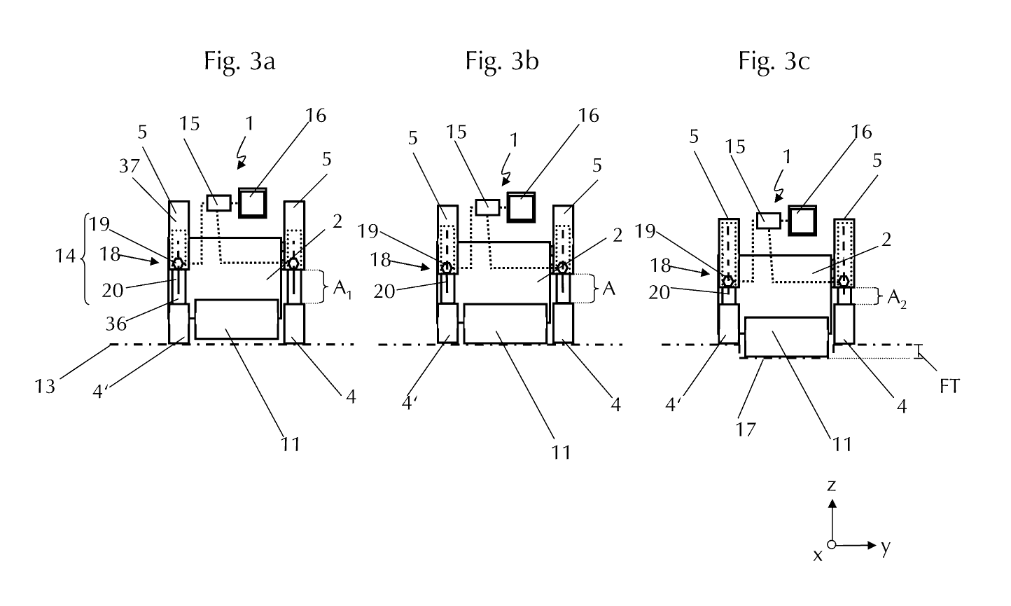

As has already been mentioned above, the position of the milling drum 11 in relation to the ground 13 to be processed can be changed by way of changing the lifting state of the two rear lifting columns 5. This is shown in closer detail in FIGS. 3a to 3c, which show a highly simplified rear view of the cold milling machine 1. The milling drum 11 is lifted in relation to the ground 13 in FIG. 3a (“transport position”), lowered in FIG. 3b onto the ground 13 to be processed (“contact position”) and lowered into the ground 13 to be processed in FIG. 3c (“working position”). The different positions can be obtained by lifting and lowering the lifting columns 5. Based on the contact position according to FIG. 3b, the lifting columns are moved apart for example or the machine frame 2 is lifted in order to reach the transport position according to FIG. 3a. The distance between the rear wheel 4 and the bottom end of the upper sleeves 37 of the lifting columns 5 is stated for illustration in FIGS. 3a to 3c. If the machine frame 2 is lifted to the transport position in FIG. 3a starting from FIG. 3b, this distance increases from distance A to distance A₁. If on the other hand the machine frame 2 is lowered to the working position according to FIG. 3c starting from FIG. 3b, the distance A decreases to the distance A₂. In the working position, the milling drum 11 plunges into the ground 13 to be processed with the depth FT in the vertical direction, which states the working depth or milling depth, and removes a milling bed 17. The desired milling depth FT can vary according to the application, so that the observance of the milling depth FT is imminently important for the operator of the cold milling machine 1.

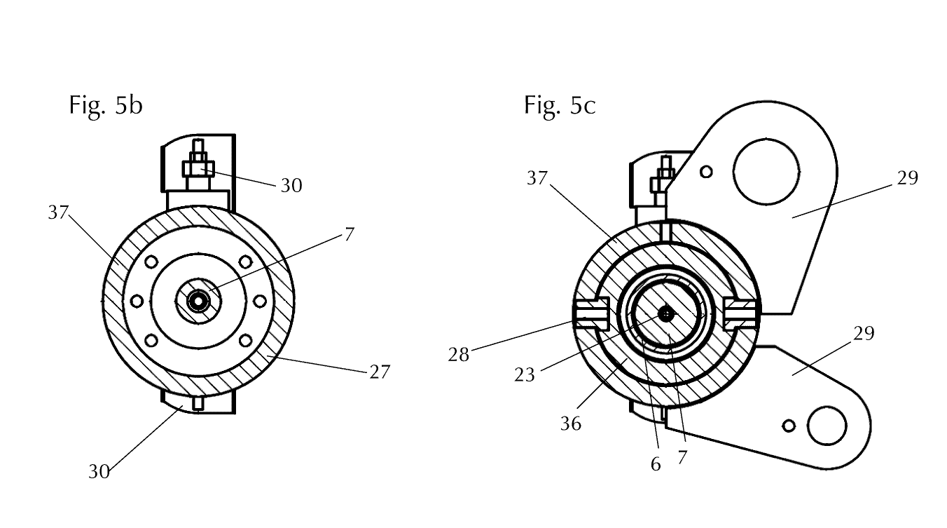

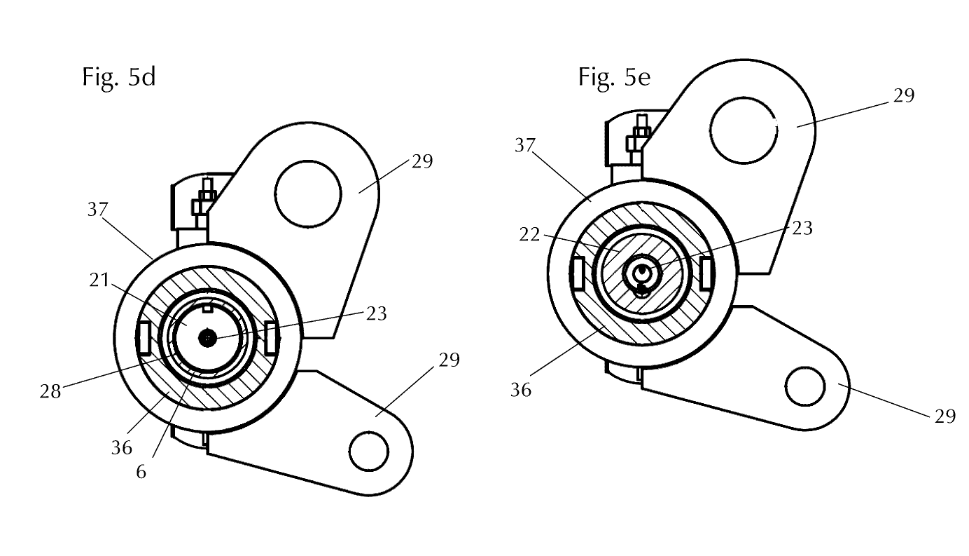

For this purpose, the cold milling machine 1 comprises a control and/or monitoring system, comprising a path measuring device 14, a control unit 15 and a display unit 16. The operator in the operator workplace 8 is shown at least the current milling depth FT via the display unit 16. The adjusting path of the lifting columns 5 can be measured with the help of the path measuring device. The path measuring device comprises for this purpose a magnetostrictive sensor 18 with a cylinder sensor element 19 arranged in the cylinder 6 and a piston sensor element 20 arranged in the piston 7. Changes in the lifting position of the respective lifting columns 5 can be determined with the help of the sensor 18, which changes are finally proportional to the height offset of the various distances A, A₁ and A₂. The concrete arrangement is shown in FIG. 5a for example.

The practical operation of the milling depth display with this system can be the transport of the cold milling machine at first to the place of application with a milling drum 11 disposed in the transport position (FIG. 3a). The milling drum 11 is lowered at first onto the ground 13 to be processed in the contact position according to FIG. 3b. The control unit 15 can be used to determine the initial value or zero value (which corresponds to a milling depth of zero). This comes with the advantage that different filling states of the tires of the rear wheels 4 and 4′ (if they do not concern solid rubber tires or caterpillar gondolas, as is usually the case) can be taken into account and the milling depth FT can be determined in an especially precise manner in this way over the entire width of the milling drum 11. Once the milling drum enters the ground 13 to be processed by lowering the machine frame 2 (which is achieved by a retraction of the lifting columns 5) according to FIG. 3c, the respective distance measuring device which is integrated in the lifting columns detects the changes in the lifting state of the lifting columns 5 with the help of the sensor 18 and transfers the determined values via respective signal lines (indicated in FIGS. 3a to 3c with the broken lines) to the control unit 15. The control unit 15 finally determines concrete milling depth values FT from the measured values and sends them to the display unit 16. It is further possible instead of the embodiment as illustrated in FIGS. 3a to 3c, to arrange a distance measuring device 14 merely on one side or in one lifting column. This applies especially when the cold milling machine does not comprise any pivotable rear wheel 4, but has wheels which are stationary with respect to the machine frame 2.

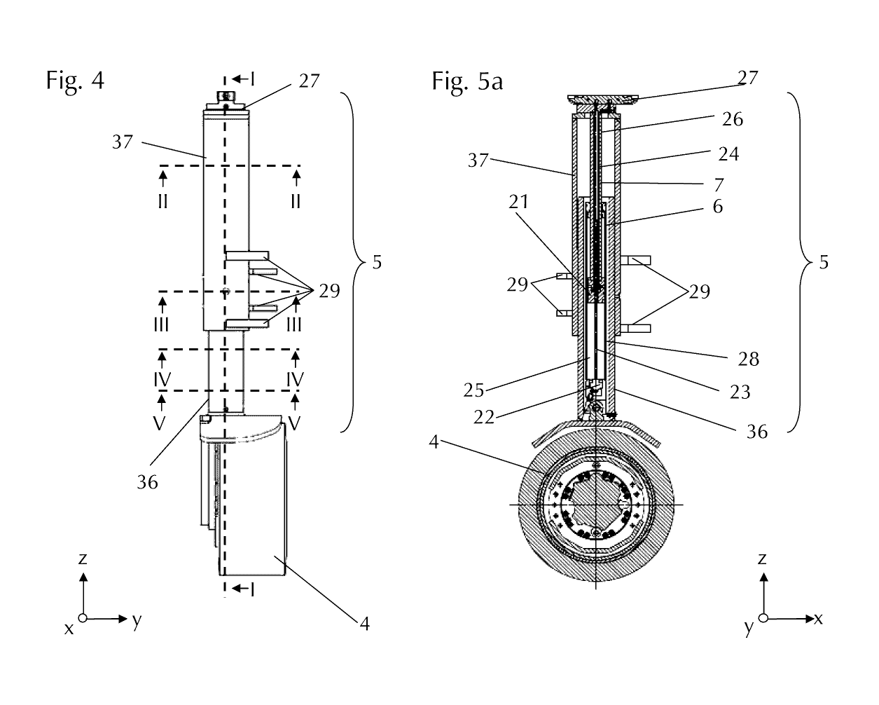

One relevant aspect of the arrangement in accordance with the present invention lies in the special arrangement of the distance measuring device 14 or sensor 18 of the distance measuring device 14 in the lifting column 5. The sensor is positioned to be disposed in the inside of lifting column 5 and thus does not protrude over the substantially evenly progressing outside surface of the lifting column (or the casing in the form of the bottom sleeve 36 and the upper sleeve 37). Specifically, the sensor is completely disposed in the interior space of the casing and therefore does not have any direct contact to the outside environment of the lifting column 5 for example. In order to further illustrate this special arrangement and the principal configuration of the magnetostrictive sensor 18, reference is hereby made to FIGS. 4 and 5a to 5d.

FIG. 4 shows the lifting column 5 of the pivotable rear wheel 4 of FIG. 1 detached from the machine frame 2 in a front view. The fixing to the machine frame 2 occurs by way of a suitable pivoting mechanism (not shown in closer detail), with which the lifting column 5 or the rear wheel 4 can be horizontally pivoted inwardly and outwardly. Respective lugs 29 are provided for this purpose on the upper sleeve 37 of the lifting column 5. The lifting column 5 or the upper sleeve 37 of the lifting column 5 is closed off by a cover 27. The cylinder/piston unit which is arranged in the interior of the lifting column 5 is connected via the hydraulic connections 32 of the hydraulic system of the cold milling machine 14 lifting and lowering the rear wheel 4. FIGS. 5a to 5e indicate different sectional views of this lifting column 5, the intersecting planes of which are designated in FIG. 4 with I to V. The section I concerns a vertical section along the cylinder axis of the piston/cylinder unit 5. The sections II to V on the other hand are horizontal sections through the lifting column 5 at different levels, with the top view of the sections being made from below, as is indicated by the respective arrows in connection with individual intersecting planes II to V in FIG. 4.

The relevant elements of the magnetostrictive sensor 18 are a position magnet 21, a signal transducer 22 and a sensor rod 23. They are arranged in an interior space 24 within the cylinder/piston unit formed by the cylinder 6 and the piston 7, or are integrated in the lifting column 5. Sensor 18 is thus completely screened to the outside by the lifting column 5 (both by the entirety consisting of the cylinder 6 and the piston 7 and also by the entirety of the bottom sleeve 36 and the upper sleeve 37) and is thus protected from weathering influences, etc. Furthermore, especially FIGS. 4 and 5a indicate the compact integration of the sensor in the lifting column 5 which is free from protrusion in relation to the outside surface of the lifting column 5, because the interior space 24 or the interior of the lifting column 5 is used for positioning the sensors. The sensor rod 23 extends with its longitudinal axis along the cylinder axis of the piston 7 and the cylinder 6. The signal transducer is arranged at the bottom face-side end of the sensor rod 23, which signal transducer is arranged for transmitting a pulse into the sensor rod 22 and for receiving an acoustic signal. Furthermore, connecting cables not designated in closer detail are provided on the signal transducer 22 as a part of the distance measuring device 14, which cables can be used for power supply and for signal transmission to the control unit 15 and can be guided out of the lifting column 5.

The signal transducer 22 is rigidly connected with the cylinder 6 and thus forms the cylinder sensor element 20 together with the sensor rod 23. The piston sensor element 19 on the other hand is the position magnet 21 which concerns an annular permanent magnet, with the sensor rod 23 being guided through its central hole in a contactless manner. The position magnet 21 is further rigidly connected with the piston 6. For this purpose, the position magnet 21 is arranged at the bottom end of the piston 7. The position magnet 21 is therefore stationary with respect to the piston 6.

For the height adjustment of the lifting column 5, the piston 7 is displaced relative to the cylinder 6, finally leading to a relative movement of the position magnet 21 relative to the signal transducer 22 along the sensor rod 23. This change in distance will be detected by magnetostrictive sensor 18 by way of signals, which are sent to the control unit 15 for further processing. In the contact position the operator can set the control unit 15 zero, which corresponds to a milling depth of zero. When the milling drum 11 is subsequently lowered into the ground to be processed, which occurs practically by moving the piston 7 into the cylinder 6, this change in the lifting position will be detected by the sensor 18. With the help of the measured data transmitted by the sensor 18, the control unit can finally determine the milling depth FT in metric or imperial units and display the same in a respective display since the change in the lifting position along the sensor rod 23 corresponds to the lowering depth of the milling drum 11 into the ground 13.

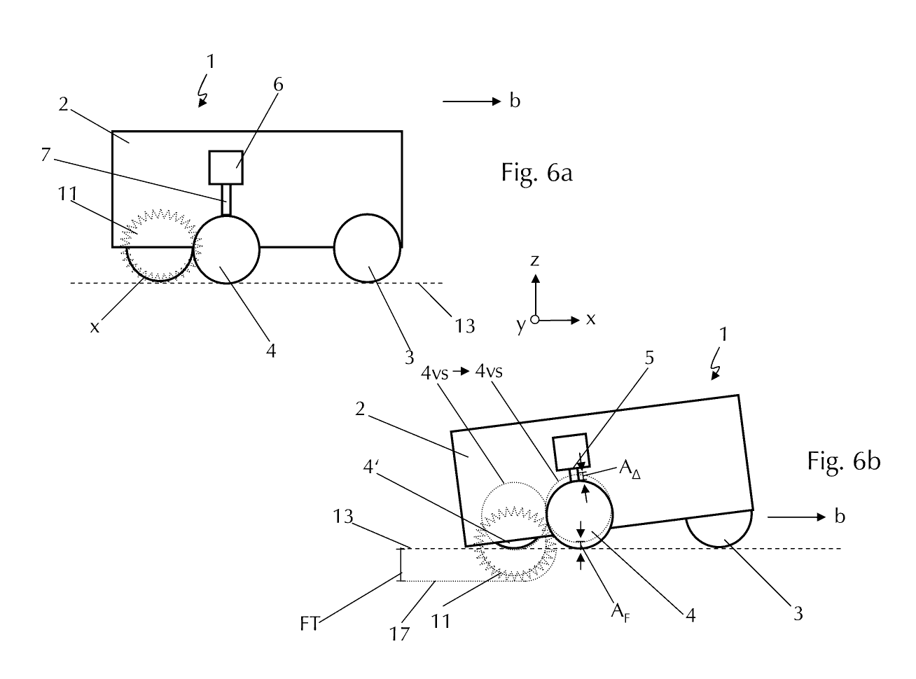

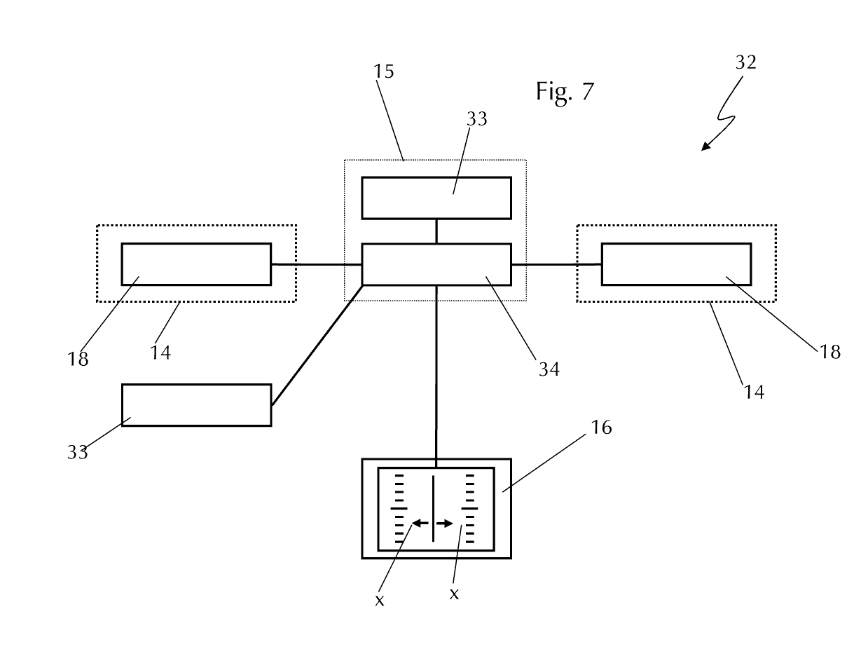

In the application of the method for determining the milling depth FT as described above, especially with the described concrete arrangement of the sensor 18, it is already possible to achieve a very precise determination of the current milling depth. However, milling machines with a pivotable wheel, especially a pivotable rear wheel 4, come with the special feature that the milling depths FT corresponding to the respective lifting states will differ in the inwardly pivoted and in the outwardly pivoted state. Reference is hereby made to FIGS. 6a and 6b for further illustration, which show the cold milling machine 1 in a highly schematic side view (with the position of the cylinder 6 and the piston 7 being exchanged in comparison to the preceding embodiment in the embodiment in FIGS. 6a and 6b and the upper and bottom sleeve 36 and 37 not being shown). The cold milling machine 1 is in the contact position in FIG. 6a, i.e., the milling drum 11 rests on the ground 13 to be processed, and in the working position in FIG. 6b, i.e., the milling drum 11 has been lowered into the ground 13 to be processed. Due to the fact that the machine frame 2 is not lowered completely but merely in the rear region, it is provided with a rearwardly dropping oblique position, as a result of which the distance of the machine frame to the ground will increase to the front or in the working direction b along the machine frame. For the same milling depth FT it is therefore necessary to lift the pivotable rear wheel 4 less in the inwardly pivoted (and forwardly offset) state than in the outwardly pivoted state. This is further illustrated in FIG. 6b by the rear wheel 4vs which is shown with the dotted line, which is shown at first in its outwardly pivoted position in the rear region of the cold milling machine 1. It is disposed there at the same height as the milling drum 11 and the non-pivotable rear wheel 4′ on the other side of the machine frame 2 (axis d of FIG. 2). This position is further shown in a projection which is forwardly offset along the longitudinal axis of the machine frame 2 in the manner that it is shown transversely to the longitudinal axis of the machine frame 2 in the working direction b at a level with the rear wheel 4 in the inwardly swiveled position (on axis e of FIG. 2). It can be seen that these two positions are positioned apart by the differential distance A_{Δ} with respect to the movement or lifting axis of the lifting column 5, which corresponds to a depth difference of A_{F} with respect to the milling depth. In order to eliminate this source of errors, the control unit 15 is arranged for performing a respective corrective function which takes into account the dependence of the milling depth FT determined with the distance measuring device 14 on the pivoting position of the rear wheel 4 which is pivotable in the horizontal plane and is therefore able to display substantially more precise values of the milling depth FT on the display element 16, which values are independent of the pivoting position. The principal sequence of this method is shown in FIG. 7 by reference to the system shown there for determining the milling depth FT.

The system 32 is set to zero at first, as has already been described above. Subsequently, the distance measuring devices 14 which are each integrated in one lifting column will detect the lifting state of the respective lifting column. It is understood that it is not mandatory to use the above sensor arrangement with the magnetostrictive sensor 18. Principally, the corrective function can then be performed by the control unit 15 when the changes in the lifting states are determined by other suitable distance measuring devices, e.g., by means of draw-wire sensors or optical distance sensors. Moreover, it can already be sufficient to provide such an arrangement merely on the pivotable rear wheel 4. It is preferable however to provide a respective distance measuring device at least on the pivotable and on the non-pivotable rear wheel, as is the case in FIG. 7. The left distance measuring device 14 is associated with the pivotable rear wheel 4 and the right distance measuring device is associated with the non-pivotable rear wheel 4′. The changes in the lifting state of lifting column with respect to the previously determined zero point as determined by the two distance measuring devices 14 are transmitted to the control unit 15. At the same time, the control unit queries the pivoting position of the pivotable rear wheel 4. A respective sensor device 33 is provided for this purpose, which is arranged in the manner that it can determine at least whether or not the pivotable rear wheel 4 is in a specific position, e.g., the inwardly pivoted position. It is ideal if this sensor device is able to positively determine whether the rear wheel 4 is in the inwardly or outwardly pivoted position. If the control unit is provided with this information in an intermediate memory 34, it decides whether or not the performance of a corrective function is necessary. In the present case the corrective option is always necessary when the rear wheel 4 is in the inwardly pivoted position, as is shown in FIG. 6b. In order to perform the corrective function, the control unit 15 invokes a corrective function stored in a read-only memory 34, with which the measured value determined by the distance measuring device 14 of the pivotable rear wheel 4 is multiplied. This corrective measure value is then displayed metrically or imperially in the digital display device 16 as the actual working depth (which corresponds to the real working depth), with the measured values of the right and left rear wheel being displayed separately from one another (16a, 16b). In this way, inclined positions can also rapidly be detected by the operator for example.

While the present invention has been illustrated by description of various embodiments and while those embodiments have been described in considerable detail, it is not the intention of Applicants to restrict or in any way limit the scope of the appended claims to such details. Additional advantages and modifications will readily appear to those skilled in the art. The invention in its broader aspects is therefore not limited to the specific details and illustrative examples shown and described. Accordingly, departures may be made from such details without departing from the spirit or scope of Applicants' invention.

What is claimed is:

1. A construction machine, comprising:
a machine frame and a chassis carrying the machine frame and including a pair of rear wheels and at least one front wheel, with at least one of the rear wheels being connected with the machine frame via a height-adjustable lifting column and the lifting column comprising a distance measuring device including a sensor for measuring an adjustment of the lifting column wherein the sensor is integrated in the lifting column and a control unit is provided for performing a corrective function for compensating different horizontal pivoting positions of one of the rear wheels.

2. A construction machine according to claim 1, wherein the sensor is arranged substantially in an interior space of the lifting column.

3. A construction machine according to claim 1, wherein the sensor is arranged in a manner that it determines the lifting state via a magnetostrictive measuring principle.

4. A construction machine according to claim 3, wherein the sensor comprises a position magnet, a signal transducer and a sensor rod, with the position magnet being displaceable along the sensor rod and with the signal transducer being arranged on a face end of the sensor rod.

5. A construction machine according to claim 1, wherein the lifting column comprises a cylinder/piston unit, and the sensor comprises a cylinder sensor element arranged in the cylinder and a piston sensor element arranged in the piston, and the sensor is arranged for determining a distance between the piston sensor element and the cylinder sensor element.

6. A construction machine according to claim 5, wherein a position magnet is the cylinder sensor element and a signal transducer is the piston sensor element.

7. A construction machine according to claim 5, wherein the sensor is arranged in the cylinder/piston unit in a manner that a longitudinal axis of a sensor rod and a cylinder axis of the cylinder/piston unit extend coaxially with respect to one another.

8. A construction machine according to claim 1, wherein the control unit processes the measured values determined by the distance measuring device of the lifting column and displays the measured values separately in a display.

9. A method for controlling and/or monitoring the working depth (FT) of a working device which is mounted on a height-adjustable construction machine for processing the ground according to claim 1,
with a height-adjustable machine frame which is carried by a chassis and to which is linked at least one wheel of the chassis in a horizontally pivotable manner, and
with at least one lifting column for the height adjustment of the machine frame relative to the at least one wheel,
and with a distance measuring device which comprises a control unit and a sensor which is connected with the lifting column and is integrated in the lifting column, comprising the steps:
a) detecting the lifting position of the at least one lifting column with the sensor;
b) transmitting the detected lifting position to the control unit;
c) querying the pivoting position of the pivotable wheel by the control unit, and
d) correcting the lifting position as detected by the sensor depending on the queried pivoting position of the pivotable wheel for determining an actual working depth.

10. A construction machine according to claim 1, wherein the construction machine comprises a road construction machine.

11. A method according to claim 9, wherein at least one wheel comprises a rear wheel.
